(19) United States
(12) Patent Application Publication
(10) Pub. No.: US 2025/0321413 A1
(43) Pub. Date: Oct. 16, 2025

(54) FILTER CHANGING DEVICE FOR OPTICAL BEAM PATHS

(71) Applicant: Carl Zeiss Microscopy GmbH, Jena (DE)

(72) Inventor: Christoph Eichhorn, Jena (DE)

(73) Assignee: Carl Zeiss Microscopy GmbH, Jena (DE)

(21) Appl. No.: 19/174,089

(22) Filed: Apr. 9, 2025

(30) Foreign Application Priority Data
Apr. 10, 2024 (DE) 10 2024 203 286.7

(51) Int. Cl. G02B 26/00

(52) U.S. Cl. CPC G02B 26/008

(57) ABSTRACT

A filter changing device for optical beam paths contains a first filter wheel and a second filter wheel for mounting and positioning in each case a number of optical elements in an optical beam path, which is configured to be moved in each case in a controlled manner along portions of a respective circular path. Additionally a common drive for the controlled production of a respective movement of the filter wheels along their respective circular path is connected to the first and second filter wheels via respective gear mechanisms, wherein each gear mechanism is embodied with a drive direction (AR) and a freewheeling direction (FR), and the drive direction (AR) and the freewheeling direction (FR) of the gear mechanisms of the first filter wheel and respectively of the second filter wheel are formed oppositely to one another.

The invention relates to a filter changing device for optical beam paths according to the preamble of the main claim.

In optical systems, in particular in microscopes and other systems for stereoscopic applications, assemblies designed as compactly and simply as possible are striven for. For optical systems, in particular for their illumination and/or detection beam paths, there is often the requirement here to be able to move different filters or stops into and out of the beam paths, for example. Moreover, it may be advantageous for optical elements kept available to be combined with one another as necessary, for example by means of rotatable filter wheels.

In order to afford free combinability of the optical elements present on the filter wheels, each of the filter wheels may have a dedicated drive. The required number of component parts and the required installation space are disadvantageous here.

One possibility for actuating a total of three filter wheels using only one drive, and at the same time providing a degree of combinability of the optical elements arranged on the filter wheels, is known from EP 3 851 893 A1. In the latter, a central one of three filter wheels is driven, while the other two are not connected to an active drive. There are present on the filter wheels entrainment pins and segmented grooves or slots which are coordinated with one another such that only the first filter wheel is entrained, i.e. driven, during a rotation of the central filter wheel in a first direction. Only the third filter wheel is entrained during a rotation in a second direction. The grooves or slots thus offer a respective freewheel for a respective one of the filter wheels in a direction of rotation of the central filter wheel.

With this solution, however, in particular on account of the dimensioning of the grooves or slots being implementable in a limited manner, the number of positions into which one of the filter wheels can be fed is limited. Moreover, each of the two filter wheels that are not actively driven is returned to an initial position again after an entrainment process by means of a restoring device in order actually to be able to use the relevant freewheel again.

The invention is based on the object of proposing a possibility—which is improved by comparison with the prior art—for the controlled driving of a plurality of filter wheels using only one drive.

The object is achieved by the subject matter of the independent claim. The dependent claims relate to advantageous developments.

A filter changing device for optical beam paths comprises a first filter wheel and a second filter wheel for mounting and positioning in each case a number of optical elements or components, such as for example colour filters, polarization filters, optical lens elements, prisms, stops and/or masks. Respectively selected filter wheels can be arranged in an optical beam path by virtue of the fact that the filter wheels together with the optical elements present in each case can be moved in a controlled manner along portions of a respective circular path and be fed to a desired position. The filter changing device has a common drive for the controlled production of a respective movement of the filter wheels along their respective circular path. In this case, the common drive is connected to the first and second filter wheels via respective gear mechanisms. Each of the gear mechanisms can be operated in a drive direction and a freewheeling direction, wherein the drive direction and the freewheeling direction of the gear mechanisms of the first filter wheel and respectively of the second filter wheel are formed oppositely to one another. In a drive direction of the gear mechanism, the associated filter wheel is rotated by a corresponding absolute angular value, while in the freewheeling direction, no drive force is guided from the common drive to the relevant filter wheel by the gear mechanism.

A filter change device according to the invention is characterized in that the portions of the circular paths each cover an angular range of more than 180°. The filter wheels can be moved over a large angular range, which advantageously increases the flexible usability in comparison with solutions in the prior art. In addition, each freewheel in the freewheeling direction is unlimited. In the course of freewheeling, a filter wheel can thus potentially be moved over any desired angular range, up to multiple complete revolutions. Moreover, a filter wheel fed to a current position (also called: angular or rotational position, rotary position) in the drive direction is held at the current position by the effect of the gear mechanism and is moved further proceeding from the current position in the event of a renewed drive in the drive direction.

In further embodiments of the filter change device according to the invention, the angular ranges of the circular paths amount to at least 270°, in particular at least 360°.

Holding at the current position can be brought about by the effect of the gear mechanism, for example, by virtue of the latter remaining in positively locking and/or force-locking contact with the filter wheel and being held there on account of its mechanical inertia and/or by the effect of a braking device (see below).

The essence of the invention is that by virtue of the design measures mentioned, using just one common drive, the filter wheels are actually moved independently of one another and any desired configurations with respect to one another can be set. The large angular range of the drive direction and the unlimited freewheel enable maximum flexibility. The possibility of starting a subsequent movement in the drive direction directly from a current position previously adopted, without first having to return to an initial position again for this purpose, as is described in the prior art, advantageously enables fast and very precise feeding to a new current position. The high feeding precision and the theoretically unlimited number of possible positions also allow a large number of optical elements to be provided on the filter wheels. In this regard, for example, a filter wheel of a filter changing device according to the invention can hold 6, 8, 9, 10 or more optical elements.

The optical elements are held in perforations (filter receptacles, henceforth also denoted by the shorter term: places) provided for the optical elements. By way of example, the optical elements can be plugged or screwed into these or held there by means of a holding device. The places of the filter wheels are advantageously standardized, such that each filter receptacle can be provided with a correspondingly designed optical element in any desired manner.

It is also possible to provide for the filter wheels to be equipped in a predetermined and fixed manner. Advantageously, however, the optical elements can be arranged interchangeably in the filter wheels. It is also possible for individual places of the filter wheels to be left free in order for example to make possible free beam passage when the relevant filter receptacle is fed to an optical beam path.

In further embodiments of the invention, the filter wheels can also have individual places which deviate from a standardized filter receptacle with regard to their size and/or angular position, for example. By way of example, individual securing possibilities for the optical elements to be held can be provided or can be retrofittable.

The filter wheels can optionally have reference markers, too, on the basis of which a current position and/or a defined zero position can be ascertained. As known from the prior art, such reference markers can be for example perforations in the filter wheels, indentations of the edge regions, protuberances (projections, lugs) protruding from the filter wheel, and/or reflective or otherwise optically detectable components. For position monitoring, for example, step counters, light barriers and/or optical sensors (cameras) can be used.

In order to be able to operate the filter changing device according to the invention in an automated and precise manner, the common drive (hereinafter also referred to for short as: drive) is advantageously embodied as a motorized drive, for example in the form of a stepper motor, a DC motor with encoder or some other motorized drive, preferably with integrated position monitoring. The drive is advantageously actuable by means of control commands from a controller. For this purpose, for example, motor control circuit boards with microcontrollers or FPGAs (field programmable gate arrays) can be used, which are in turn controlled by a superordinate control computer.

The first and second gear mechanisms of the filter changing device according to the invention can be in contact with the filter wheel by means of a respective gearwheel drive or by means of a respective friction wheel drive, for example. A positively locking connection between gear mechanism and filter wheel would thus be created in the first case, and a force-locking connection in the second case. Force transmission by means of belts, in particular by means of toothed belts, is also conceivable.

The regions of the filter wheels that serve to transmit drive forces, and optionally braking forces (see below), can be formed in portions or circumferentially on the outer end face of said filter wheels and/or on at least one of their side faces, advantageously in the region of the outer edge. The regions can be teeth or tracks of a friction wheel drive.

In order to avoid undesirable crosstalk of movements of the filter wheels on one another, each filter wheel can be assigned a braking device. The term braking device can be understood broadly. By way of example, the first or respectively the second gear mechanism itself can also act as a braking device. If for example the teeth of a gear mechanism configured as a gearwheel gear mechanism are continuously in engagement with one another, the filter wheel is prevented from an unwanted rotational movement. The setting of the required braking torque by means of the coordination of the frictional forces between the gear mechanism partners and the mountings thereof proves to be advantageous. Furthermore, additional components such as rotary brakes or latching devices can be present and used.

The filter changing device according to the invention can advantageously be used in optical arrangements such as microscopes, illumination or detection devices, zoom systems or optical measuring and test devices. In this case, in one embodiment, the filter wheels can be placed into a common beam path. In a further embodiment of the invention, each of the filter wheels can be placed into different beam paths. In this case, the beam paths can be illumination beam paths and/or detection beam paths, for example.

In order to place the filter wheels into a common beam path and in order to make a compact design possible, the filter wheels can be arranged on a common axis of rotation. In contrast thereto, the filter wheels can be arranged on different axes of rotation if they are intended to be fed to two different beam paths.

The invention is explained in greater detail below on the basis of exemplary embodiments and with reference to drawings, in which:

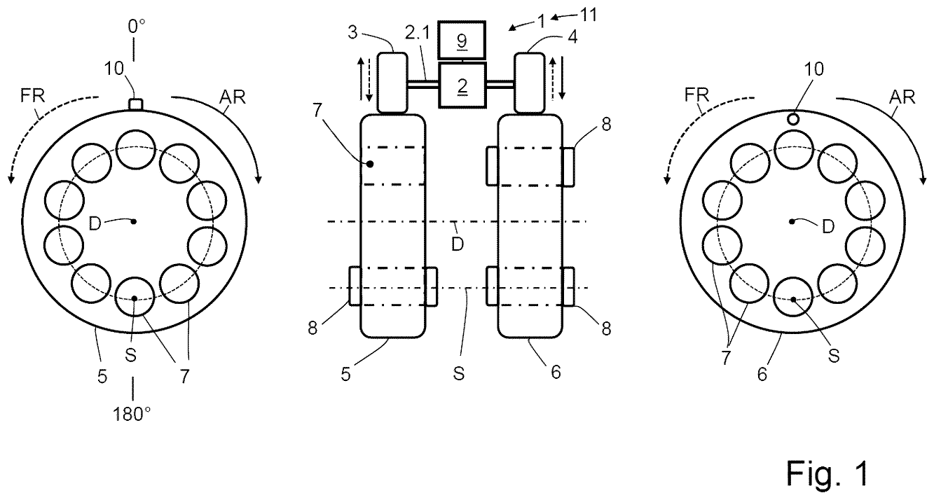

FIG. 1 shows schematic illustrations of a first exemplary embodiment of a filter changing device according to the invention in a lateral view and in respective lateral views of the filter wheels present;

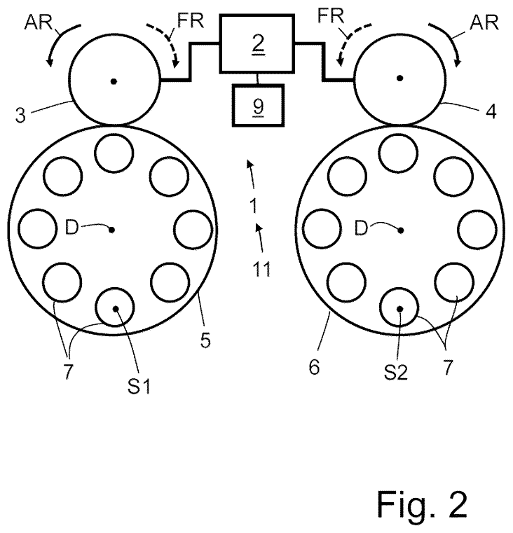

FIG. 2 shows a schematic illustration of a second exemplary embodiment for arrangement on two different beam paths; and

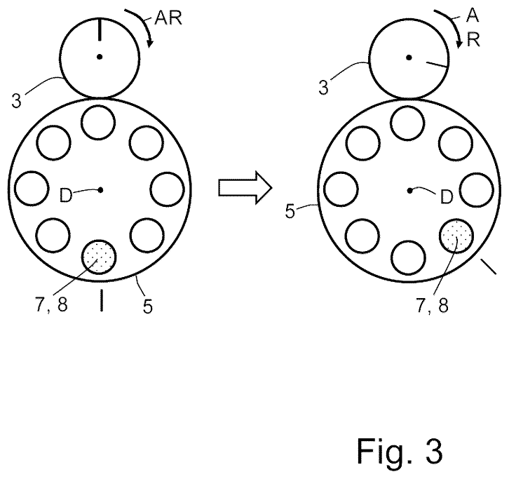

FIG. 3 shows a schematic illustration of a process of feeding a filter wheel to a new current position by means of a filter changing device according to the invention.

In the figures concerning the exemplary embodiments, identical technical elements are provided with the same reference signs.

As essential elements of a filter changing device 1 according to the invention, there are present a drive 2 and also a first gear mechanism 3 and a second gear mechanism 4, which can be driven by the effect of the drive 2, and also a first filter wheel 5 and a second filter wheel 6 (FIG. 1). A driveshaft 2.1 for transmitting force from the drive 2 to the gear mechanisms 3, 4 is illustrated by way of example. The first gear mechanism 3 is in contact with the first filter wheel 5, this contact enabling force to be transmitted from the first gear mechanism 3 to the first filter wheel 5. The same correspondingly applies to the second gear mechanism 4 connected to the second filter wheel 6. The drive 2 is advantageously a motor that can be actuated with regard to its respective direction of rotation, and the angular range respectively swept over in this case, by means of a controller 9. The filter changing device 1 can be part of a microscope 11 (not illustrated in more specific detail).

Both gear mechanisms 3 and 4 are provided with a freewheel (freewheeling direction FR) in a direction of their mechanical force flow, while in the opposite direction force is guided from the drive 2 to the relevant gear mechanisms 3, 4 (drive direction AR). Both directions are symbolized by arrows with different line types, besides the reference signs.

The gear mechanisms 3, 4 have for example a drive wheel, for example in the form of a gearwheel or a friction wheel, in order to guide a force to the filter wheel 5 or respectively 6 assigned to the relevant gear mechanism 3, 4.

In the middle sub-figure, the filter changing device 1 is shown in a view of the respective circumferential end faces of the gear mechanisms 3, 4 and of the filter wheels 5, 6 positioned parallel to one another. The two filter wheels 5, 6 can be rotated about a common axis of rotation D and through angular ranges correspondingly predefined in each case on the part of the gear mechanisms 3, 4.

The filter wheels 5, 6 have a plurality of filter receptacles 7, which can receive and hold for example variably different optical elements 8 such as filters, lens elements, stops, prisms, masks and/or polarizing elements (sub-figure middle). It is also possible for individual filter receptacles 7 not to be equipped, in order to allow radiation to pass through without being influenced (see for example filter wheel 5, upper filter receptacle 7). For reasons of clarity, only two each of the filter receptacles 7 present are shown by way of example in the middle sub-figure). In the exemplary embodiment, the filter receptacles 7 are arranged on a circular path (see lateral views, symbolized by an interrupted circle). The filter receptacles 7 shown in the 180° position in the example are fed to a common beam path S. Radiation propagating along the beam path S passes through the optical elements 8 situated in the beam path S and they influence it according to the properties thereof. Rotation of at least one of the filter wheels 5, 6 into a new current position causes a different combination of optical elements 8 and/or unoccupied filter receptacles 7 to be placed into the beam path S.

In order to determine a current rotational position of the filter wheels 5, 6, besides step counters being present on the drive 2 or on the gear mechanisms 3, 4, reference marks 10 can also be present on the filter wheels 5, 6. By way of example, as reference mark 10, a projection (“lug”) protruding from the edge is present on the first filter wheel 5 and a perforation is present on the second filter wheel 6. The reference mark's position or passage through a predetermined zero position can be detected for example by means of a tactile sensor, an induction sensor, a camera or a light barrier (none being shown). Further possible reference marks 10 can be realized by reflective elements. Other arrangements, forms and dimensionings of reference markers 10 are likewise possible.

The drive directions AR and the freewheeling directions FR of the gear mechanisms 3, 4 are opposite to one another, as is illustrated by the arrows in the middle sub-figure. By way of example, if the driveshaft 2.1 is rotated in the anticlockwise direction from a lateral view from the left, the first gear mechanism 3 operates in the drive direction AR and the first filter wheel 5 is moved a specific distance in the clockwise direction.

In the meantime the second gear mechanism 4 is in the freewheeling direction FR, and so the second filter wheel 6 remains at its present position. If there is a change in the direction of the force flow on the part of the drive 2, i.e. in this example if there is a direction change pertaining to the direction of rotation of the drive shaft 2.1, the second filter wheel 6 is driven and the first filter wheel 5 remains at its current position (rotational position; see also below concerning FIG. 3).

FIG. 2 shows a second exemplary embodiment of a filter changing device 1 according to the invention, the filter wheels 5, 6 in this embodiment each being fed to a different beam path S1 and S2, respectively. For this purpose, the filter wheels 5, 6 are placed next to one another. In further possible embodiments, the filter wheels 5, 6 can be arranged parallel to one another, but laterally offset with respect to one another.

The functioning of the filter changing device 1 according to the invention is elucidated in FIG. 3 on the basis of the example of the first gear mechanism 3 and the first filter wheel 5. In the left sub-figure, the first filter wheel 5 has been fed to a current position in which, by way of example, there is a filter receptacle 7 with an optical element 8 (illustrated in a dotted manner) in a 180° rotational position.

It would be possible to bring the second filter wheel 6 (not shown) into a new current position if the drive 2 is actuated in such a way that it drives the second gear mechanism 4 in its drive direction AR, while the first gear mechanism 3 is operated in its freewheeling direction FR. The first filter wheel 5 is thus stationary, while the second filter will 6 is correspondingly moved.

In order to bring the first filter wheel 5 from the current position into a new position (rotary position, rotational position), the drive 2 is actuated by means of control commands from the controller 9 in such a way that this guides a force to the first gear mechanism 3 in the drive direction AR thereof. According to the desired new position of the first filter wheel 5, the first gear mechanism 3 is moved by a specific angle according to the transmission ratio (illustrated by line marks).

In this case, neither the filter wheels 5, 6 nor the gear mechanisms 3, 4 have to be returned to an initial position. On account of the unlimited freewheel of the gear mechanisms 3, 4, each of the filter wheels 5, 6 can be rotated through any desired angular ranges, also more than 360°. At the same time the gear mechanisms 3, 4 remain in contact with the filter wheels 5, 6, thereby preventing unintentional adjustment of one filter wheel during a movement of the other filter wheel.

### REFERENCE SIGNS

1 Filter changing device
2 Drive
2.1 Driveshaft
3 First gear mechanism
4 Second gear mechanism
5 First filter wheel
6 Second filter wheel
7 Filter wheel, eye, filter receptacle
8 Optical element
9 Controller
10 Reference mark
11 Microscope
AR Drive direction
D Axis of rotation
FR Freewheeling direction
S, S1, S2 Beam path

1. A filter changing device for optical beam paths, comprising:
a first filter wheel and a second filter wheel for mounting and positioning in each case at least one optical element in an optical beam path, wherein the optical element is configured to be moved in each case in a controlled manner along portions of a respective circular path;
a common drive for a controlled production of a respective movement of the first filter wheel and the second filter wheel along their respective circular path, wherein
the common drive is connected to the first filter wheel and the second filter wheel via respective gear mechanisms, wherein each gear mechanism is embodied with a drive direction (AR) and a freewheeling direction (FR),
the drive direction (AR) and the freewheeling direction (FR) of the gear mechanisms of the first filter wheel and respectively of the second filter wheel are formed oppositely to one another,
wherein
portions of the respective circular paths each cover an angular range of more than 180°;
each freewheel in the freewheeling direction (FR) is unlimited, and
a first filter wheel and a second filter wheel fed to a current position in the drive direction (AR) is held at the current position by the respective gear mechanism and is moved further proceeding from the current position in an event of a renewed force flow in the drive direction (AR).

2. The filter changing device according to claim 1, wherein the angular ranges of the circular paths amount to at least 270°.

3. The filter changing device according to claim 1, wherein the common drive is a motorized drive.

4. The filter changing device according to claim 1, wherein the first filter wheel and the second filter wheel are assigned a braking device, the effect of the braking device preventing crosstalk of movements of the first filter wheel and the second filter wheel on one another.

5. The filter changing device according to claim 1, wherein each respective gear mechanism is in contact with the first filter wheel and the second filter wheel by a respective gearwheel drive.

6. The filter changing device according to claim 1, wherein each respective gear mechanism is in contact with the first filter wheel and the second filter wheel by a respective friction wheel drive.

7. The filter changing device according to claim 1, wherein the first filter wheel and the second filter wheel are arranged on a common axis of rotation (D).

8. The filter changing device according to claim 1, wherein the first filter wheel and the second filter wheel are arranged on different axes of rotation (D).

9. A microscope, comprising:
a filter changing device according to claim 1.
